(19) United States
(12) Patent Application Publication
(10) Pub. No.: US 2023/0354851 A1
(43) Pub. Date: Nov. 9, 2023

(54) Pet Food Compositions

(71) Applicant: Hill's Pet Nutrition, Inc., Topeka, KS (US)

(72) Inventors: Luis J. MONTELONGO, Lawrence, KS (US); Christopher WALDY, Maple Hill, KS (US); John Michael MCCOY, JR., Topeka, KS (US); Melissa VANCHINA, Lawrence, KS (US)

(73) Assignee: Hill's Pet Nutrition, Inc., Topeka, KS (US)

(21) Appl. No.: 18/312,757

(22) Filed: May 5, 2023

Related U.S. Application Data
(60) Provisional application No. 63/338,721, filed on May 5, 2022.

(51) Int. Cl. A23K 20/126; A23K 10/22; A23K 20/142; A23K 50/40

(52) U.S. Cl. CPC A23K 20/142; A23K 10/22; A23K 20/126; A23K 50/40

(57) ABSTRACT

Described herein are pet food compositions comprising from about 10 wt.% to about 50 wt.% protein; from about 10 wt.% to about 40 wt.% fat; up to about 20 wt.% fiber; and a moisture content of from about 6 wt.% to about 10 wt.%; wherein the weight percentages are based on the total weight of the pet food composition; wherein the pet food composition has a peak force of from about 5 kg to about 11 kg. Methods of making and using these compositions are also described herein.

### CROSS-REFERENCE TO RELATED APPLICATION

This application claims the benefit of priority from U.S. Provisional Application No. 63/338,721, filed May 5, 2022, entitled “Pet Food Compositions,” the contents of which are hereby incorporated herein in their entireties, for all purposes.

### BACKGROUND

As reported by the Animal Cancer Foundation, there are approximately sixty-five million dogs and about thirty-two million cats in the United States. Of these, roughly six million new cancer diagnoses are made in dogs and a similar number made in cats each year. Cancer in the companion animal population is a spontaneous disease often similar to cancer seen in humans; some examples include non-Hodgkin’s lymphoma, prostate cancer, head and neck carcinoma, mammary carcinoma, melanoma, soft tissue sarcoma and osteosarcoma (see, http://www.acfoundation.org). As such, cancer remains a serious concern for pet owners.

Food acceptance by pets is driven by the sensory properties of food such as aroma, texture and flavor. Pets may be initially attracted to food primarily based on its scent; however, in terms of palatability, texture plays a crucial role. Texture of a dry food kibble is a key attribute for the liking of the food by dogs and cats. An unpleasant or unappealing texture may cause pets to ignore the food, regardless of its scent and ultimately result in the pet missing out on crucial nutrients. A texture that is enjoyed by the pet may make foods that they would otherwise ignore based on its taste or smell more appealing and therefore make them more likely to eat the food.

Getting pets to eat, especially sick pets, can be a problem for pet parents. This is particularly an issue for pets that are suffering from cancer. The cancer itself may have a negative impact on their desire or ability to eat. Pets that have tumors in the mouth, face, head, neck, stomach, intestines, anal glands may find it painful to eat. In other situations, pets with cancer may be receiving treatments, such as chemotherapy, radiation or surgery that affects their appetite regulation, cause nausea, or reduces their sense of taste or smell which impacts desire to eat or create side effects that interfere with eating and digestion. Further, pet owners and veterinarians consider appetite and enthusiasm for eating a key indicator of the state of their pet’s quality of life. Often when a pet with cancer does not eat well, this is a cue to the pet owner that pet’s quality of life is declining and may elect euthanasia so as to not prolong their pet’s suffering. However, if a pet with cancer eats well and seems to enjoy their meal, then the pet owner considers their pet’s quality of life is still good and believes their pet is not suffering.

Pets that are sick may still eat but just not the quantity of food that they would have before they became sick. Because pet foods are complete and balanced providing all nutrients including calories, protein, fatty acids, vitamins and minerals. If a pet eats some food but not enough, they may eat less of critical nutrients they need and if this happens frequently, these pets may suffer from chronic undernutrition which can affect their overall health, quality of life, impede recovery or even reduce survival time. Undernutrition of calories can lead to weight loss, loss of body fat and muscle. Too little protein can cause muscle wasting, affect immune system functions, as well as other body organ systems. Undernutrition of fatty acids can lead to skin lesions, hair coat issues, and a poor immune system. Inadequate fiber consumption can lead to digestive upsets and diarrhea. Undernutrition of vitamins and minerals can lead to issues such as bone demineralization, lethargy and weakness.

As such, there is a need for pet foods that entice sick pets to eat and at the same time provide essential nutrients in a condensed volume of food, so pets consume enough food and nutrients to prevent chronic undernutrition. There are technical challenges to make pet foods with palatability attributes, high calorie and nutrient density that are extremely appealing to sick pets.

Formulating a product with high fat, high protein and non-structure forming high fiber in a highly caloric and dense kibble is a technical challenge. The high fat and high protein inclusion level generally makes a high-density kibble, which does not absorb fat readily making for a greasy unappealing kibble which the sick pets might not like.

Certain embodiments of the present invention are designed to overcome these challenges and address the aforementioned needs.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

In some embodiments, the present invention provides a pet food composition comprising: from about 10 wt.% to about 50 wt.% protein; from about 10 wt.% to about 40 wt.% fat; and up to about 20 wt.% fiber; wherein the pet food composition has a peak force of from about 5 kg to about 11 kg.

Other embodiments of the present invention provide method for: increasing caloric intake; increasing body weight; improving quality of life; reducing atrophy (e.g., muscular atrophy); enhancing immunity; and/or reducing bone demineralization, in a companion animal, comprising administering to a companion animal in need thereof, anyone of the pet food compositions described herein.

Use of any one of the pet food compositions described herein, for: increasing caloric intake; increasing body weight; improving quality of life; reducing atrophy (e.g., muscular atrophy); enhancing immunity; and/or reducing bone demineralization, in a companion animal in need thereof.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other compositions and methods. Before explaining the disclosed embodiments of the present invention in detail, it is to be understood that the invention is not necessarily limited in its application to the details of any particular embodiment disclosed. The terminology used herein is for the purpose of description and not of limitation.

As used herein and in the appended claims, the singular forms “a”, “an”, and “the” include plural references unless the context dictates otherwise. The singular form of any class of the ingredients refers not only to one ingredient within that class, but also to a mixture of those ingredients. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range. Thus, a range from 1-5, includes specifically 1, 2, 3, 4 and 5, as well as subranges such as 2-5, 3-5, 2-3, 2-4, 1-4, etc. The term “about” when referring to a number means any number within a range of 10% of the number. For example, the phrase “about 2.0 wt.%” refers to a number between and including 1.8 wt.% and 2.2 wt.%.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt.%” means percent by weight with respect to the pet food composition. The symbol “°” refers to a degree, such as a temperature degree or a degree of an angle. The symbols “h”, “min”, “mL”,“nm”, “µm” means hour, minute, milliliter, nanometer, and micrometer, respectively. The abbreviation “UV-VIS” as referring to a spectrometer or spectroscopy, means Ultraviolet-Visible. The abbreviation “rpm” means revolutions per minute.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

All components and elements positively set forth in this disclosure can be negatively excluded from the claims. In other words, the pet food compositions of the instant disclosure can be free or essentially free of all components and elements positively recited throughout the instant disclosure. In some instances, the pet food compositions of the present disclosure may be substantially free of non-incidental amounts of the ingredient(s) or compound(s) described herein. A non-incidental amount of an ingredient or compound is the amount of that ingredient or compound that is added into the pet food composition by itself. For example, a pet food composition may be substantially free of a non-incidental amount of an ingredient or compound, although such ingredient(s) or compound(s) may be present as part of a raw material that is included as a blend of two or more compounds. Substantially free, unless other defined or described herein, typically refers to an ingredient or compound in an amount of about 2 wt.% or less, about 1.5 wt.% or less, about 1 wt.% or less, about 0.5 wt.% or less, about 0.1 wt.% or less, or about 0.05 wt.% or less, or about 0.01 wt.% or less, based on the total weight of the pet food composition on a dry matter basis.

As used herein, the term “a companion animal” refers to an animal of any species kept by a caregiver as a pet or any animal of a variety of species that have been widely domesticated as pets, including dogs (Canis familiaris) and cats (Felis domesticus), whether or not the individual animal is kept solely or partly for companionship. Thus, companion animals include, for example and not limitation, working dogs, farm cats kept for rodent control, pet cats, pet dogs, ferrets, birds, reptiles, rabbits, and fish. In some embodiments, the companion animal is selected from a canine and a feline. In other embodiments, the companion animal is a canine.

As used herein, the term “soluble fiber” means one or more fibers that are readily fermented in the large intestine, e.g., beet pulp, guar gum, chicory root, psyllium, pectin, blueberry, cranberry, squash, apples, oats, beans, citrus, or barley.

In some embodiments, compositions of the present invention may contain an “insoluble fiber” source. In some embodiments, insoluble fiber may be supplied by any of a variety of sources, including cellulose, whole wheat products, wheat oat, corn bran, flax seed, grapes, celery, green beans, cauliflower, potato skins, fruit skins, vegetable skins, peanut hulls, and soy fiber. The pet food compositions may comprise cellulose, hemicellulose, or a combination thereof. In at least one preferred embodiment, the pet food composition comprise cellulose and hemicellulose.

In instances when the composition is an animal’s food, vitamins and minerals can be included in amounts required to avoid deficiency and maintain health. These amounts are readily available in the art. The Association of American Feed Control Officials (AAFCO) provides recommended amounts of such ingredients for dogs and cats. See Association of American Feed Control Officials. Official Publication, pp. 126-140 (2003).

Vitamins useful as food additives include, e.g., vitamin A, vitamin B₁, vitamin B₂, vitamin B₆, vitamin B₁₂, vitamin C, vitamin D, vitamin E, vitamin H (biotin), vitamin K, folic acid, inositol, niacin, and pantothenic acid. Minerals and trace elements useful as food additives include calcium, phosphorus, sodium, potassium, magnesium, copper, zinc, choline, and iron salts.

The compositions of the present invention may further contain additives known in the art. Such additives should be present in amounts that do not impair the purpose and effect provided by the invention. Examples of additives include substances with a stabilizing effect, organoleptic substances, processing aids, and substances that provide nutritional benefits.

Stabilizing substances may increase the shelf life of the composition. Suitable examples can include preservatives, antioxidants, synergists and sequestrants, packaging gases, stabilizers, emulsifiers, thickeners, gelling agents, and humectants. Examples of emulsifiers and/or thickening agents include gelatin, cellulose ethers, starch, starch esters, starch ethers, and modified starches.

Additives for coloring, palatability, and nutritional purposes can include colorants, salts (including but not limited to sodium chloride, potassium citrate, potassium chloride, and other edible salts), vitamins, minerals, and flavoring. The amount of such additives in a composition typically is up to about 5% by weight (on a dry matter basis of the composition). Other additives can include antioxidants, omega-3 fatty acids, omega-6 fatty acids, glucosamine, chondroitin sulfate, vegetable extracts, herbal extracts, etc.

The term “palatability”, as used herein, encompasses all of the various properties of the food sensed by the animal, such as texture, taste and aroma.

Some embodiments of the present invention comprise a carbohydrate source. The carbohydrate source can comprise cereals, grains, corn, wheat, rice, oats, corn grits, sorghum, grain sorghum/milo, wheat bran, oat bran, amaranth, Durum, and/or semolina.

Some embodiments of the present invention comprise a fat source. The fat source, or fat ingredient, can comprise poultry fat, chicken fat, turkey fat, pork fat, lard, tallow, beef fat, vegetable oils, corn oil, soy oil, cottonseed oil, palm oil, palm kernel oil, linseed oil, canola oil, rapeseed oil, fish oil, menhaden oil, anchovy oil, and/or olestra.

In some embodiments, the pet food composition is formulated to include fat in an amount typically ranging from about 10 wt.% or more, based on the total weight of the pet food composition on a dry matter basis. For example, the amount of fat present in the pet food composition may be in a range from about 10 to about 60 wt.%, about 10 to about 55 wt.%, about 10 to about 50 wt.%, about 10 to about 45 wt.%, about 10 to about 40 wt.%, about 10 to about 35 wt.%, about 10 to about 30 wt.%; from about 11 to about 60 wt.%, about 11 to about 55 wt.%, about 11 to about 50 wt.%, about 11 to about 45 wt.%, about 11 to about 40 wt.%, about 11 to about 35 wt.%; from about 12 to about 60 wt.%, about 12 to about 55 wt.%, about 12 to about 50 wt.%, about 12 to about 45 wt.%, about 12 to about 40 wt.%, about 12 to about 35 wt.%; from about 13 to about 60 wt.%, about 13 to about 55 wt.%, about 13 to about 50 wt.%, about 13 to about 45 wt.%, about 13 to about 40 wt.%, about 13 to about 35 wt.%; from about 13 to about 30 wt.%, about 13 to about 25 wt.%, about 13 to about 20 wt.%, about 13 to about 15 wt.%, about 13 to about 14 wt.%, based on the total weight of the pet food composition on a dry matter basis.

The term “fat” generally refers to a lipid or mixture of lipids that may generally be a solid or a liquid at ordinary room temperatures (e.g., 25° C.) and pressures (e.g., 1 atm). In some instances, the fat may be a viscous liquid or an amorphous solid at standard room temperature and pressure.

Other embodiments of the present invention comprise additional ingredients. For example, these additional ingredients can include active ingredients, such as sources of fiber, minerals, vitamins, amino acids, carotenoids, antioxidants, fatty acids, glucose mimetics, probiotics, prebiotics, and others.

Sources of fiber can include, for example, fructooligosaccharides (FOS), beet pulp, mannanoligosaccharides (MOS), oat fiber, citrus pulp, carboxymethylcellulose (CMC), guar gum, gum arabic, apple pomace, citrus fiber, fiber extracts, fiber derivatives, dried beet fiber (sugar removed), cellulose, a-cellulose, galactooligosaccharides, xylooligosaccharides, and oligo derivatives from starch, inulin, psyllium, pectins, citrus pectin, guar gum, xanthan gum, alginates, gum arabic, gum talha, beta-glucans, chitins, lignin, celluloses, non-starch polysaccharides, carrageenan, reduced starch, soy oligosaccharides, trehalose, raffinose, stachyose, lactulose, polydextrose, oligodextran, gentioligosaccharide, pectic oligosaccharide, and/or hemicellulose.

Mineral sources can include, for example, sodium selenite, monosodium phosphate, calcium carbonate, potassium chloride, ferrous sulfate, zinc oxide, manganese sulfate, copper sulfate, manganous oxide, potassium iodide, and/or cobalt carbonate. In some embodiments, pecan shells may also be a source of lignin-based fiber.

Suitable vitamins may include choline chloride, vitamin E, ascorbic acid, vitamin A acetate, calcium pantothenate, pantothenic acid, biotin, thiamine mononitrate (source of vitamin B1), vitamin B12 supplement, niacin, riboflavin supplement (source of vitamin B2), inositol, pyridoxine hydrochloride (source of vitamin B6), vitamin D3 supplement, folic acid, vitamin C, and/or ascorbic acid.

In some embodiments, the pet food compositions may include one or more sclereid. The one or more sclereids may be obtained from nut shells, such as pecan shells, almonds shells, walnut shells, etc.; from seeds, such as pea, bean, soybean seeds, etc.; and/or from fruit skins, such as pear skin, etc. In one embodiment, the pet food composition includes pecan shell particles comprising one or more sclereids. The sclereid(s) may have a microscopic structure and, preferably, serve as an abrasive. For instance, the sclereid(s) may be selected to provide mechanical disruption of debris, food, and/or bacteria on the teeth of a pet consuming a pet food composition disclosed herein, which contains such sclereid(s). In at least one embodiment, the sclereid(s) may be selected to include one or more polyphenols.

Sources of polyphenols ingredients can include tea extract, rosemary extract, rosemarinic acid, coffee extract, pecan shells, caffeic acid, turmeric extract, blueberry extract, grape extract, grapeseed extract, and/or soy extract.

The pet food compositions may include one or more phenols, e.g., in an amount from about 0.01 to about 10 wt.%, based on the total weight of the pet food composition on a dry matter basis. In some instance, the amount of phenols present in the pet food composition is from about 0.01 to about 10 wt.%, about 0.01 to about 8 wt.%, about 0.01 to about 6 wt.%, about 0.01 to about 5 wt.%, about 0.01 to about 4 wt.%, about 0.01 to about 3 wt.%, about 0.01 to about 2 wt.%, about 0.01 to about 1 wt.%, about 0.01 to about 0.5 wt.%, about 0.01 to about 0.1 wt.%; from about 0.05 to about 10 wt.%, about 0.05 to about 8 wt.%, about 0.05 to about 6 wt.%, about 0.05 to about 5 wt.%, about 0.05 to about 4 wt.%, about 0.05 to about 3 wt.%, about 0.05 to about 2 wt.%, about 0.05 to about 1 wt.%, about 0.05 to about 0.5 wt.%, about 0.05 to about 0.1 wt.%; from about 0.1 to about 10 wt.%, about 0.1 to about 8 wt.%, about 0.1 to about 6 wt.%, about 0.1 to about 5 wt.%, about 0.1 to about 4 wt.%, about 0.1 to about 3 wt.%, about 0.1 to about 2 wt.%, about 0.1 to about 1 wt.%; from about 0.5 to about 10 wt.%, about 0.5 to about 8 wt.%, about 0.5 to about 6 wt.%, about 0.5 to about 5 wt.%, about 0.5 to about 4 wt.%, about 0.5 to about 3 wt.%, about 0.5 to about 2 wt.%, about 0.5 to about 1 wt.%; from about 1 to about 10 wt.%, about 1 to about 8 wt.%, about 1 to about 6 wt.%, about 1 to about 5 wt.%, about 1 to about 4 wt.%, about 1 to about 3 wt.%, about 1 to about 2 wt.%; from about 2 to about 10 wt.%, about 2 to about 8 wt.%, about 2 to about 6 wt.%, about 2 to about 5 wt.%, about 2 to about 4 wt.%; from about 3 to about 10 wt.%, about 3 to about 8 wt.%, about 3 to about 6 wt.%, about 3 to about 5 wt.%; from about 4 to about 10 wt.%, about 4 to about 8 wt.%, about 4 to about 6 wt.%; from about 5 to about 10 wt.%, about 5 to about 8 wt.%, or any range or subrange thereof, based on the total weight of the food composition on a dry weight basis.

The one or more of the phenols may be selected from flavonoids, lignans, metabolic enhancers, and a combination of two or more thereof. Examples of lignin that may be included in the pet food composition include coniferyl alcohol, sinapyl alcohol, paracoumaryl alcohol, and combinations of two or more thereof. Non-limiting examples of flavonoids include, but are not limited to, flavones, flavonols and flavonones, which reportedly protect the vascular system and act to reduce allergies, inflammation, viruses and tumors. Flavonols reportedly strengthen the intertwined strands of collagen protein. Anthocyanidins, a type of flavonol may scavenge free radicals. Catechins and gallic acids are a type of flavonoid that reportedly have chemoprotective properties. Isoflavonoes reportedly block enzymes that promote tumor growth. Glucosinolates and allyl sulfides, both types of thiol phytonutrients, reportedly possess antimutagenic and anticarcinogenic properties as well as immune and cardiovascular protection in humans. Indoles interact with vitamin C and may bind carcinogens and enzymes. Isoprenoids neutralize free radicals. Lipoic acid and ubiquinone may act as antioxidants to extend the effects of other antioxidants. Natural sources of the at least one flavonoid and/or their conjugates may be selected from the group consisting of black or green tea, capers, lovage, apples, onion, in particular red onion, red grapes, citrus fruit, tomato, broccoli, raspberry, bog whortleberry, lingonberry, cranberry, chokeberry, sweet rowan, rowanberry, sea buckthorn berry, crowberry, prickly pear cactus fruit, or combinations thereof.

The metabolic enhancer may be selected from lipoic acid, taurine, carnitine, betaine (trimethylglycine), coenzyme Q10, beta-alanine, pyrroloquinoline quinone (PQQ), creatine, and a combination of two or more thereof. In one embodiment, the metabolic enhancer is lipoic acid, carnitine, or a combination thereof. In further embodiments, the pet food composition may contain added carnitine between 0.01 and 0.1%, added taurine between 0.1 and 0.5%, added betaine between 0.25 and 1% and/or added lipoic acid between 0.005 and 0.05%. Due to species differences, lipoic acid is not included in companion animal feline formulations. The inventors recognized that for some embodiments enhanced benefits of the pet food composition can be achieved by increasing to allow increased fat metabolism, e.g., under a ketogenic diet. For instance, it is believed that ketogenic diet induces a metabolic burden for catabolism of dietary fat due to the large percentage of energy intake as fat and can changes in gene expression and enzyme activity that result in a metabolic shift toward fat metabolism and increased energy expenditure. In fact, it may be that a ketogenic diet is not maximally valuable unless sufficient ancillary factors are available to allow increased fat metabolism.

The inventors recognized that certain additives may be advantageously incorporated to reduce or obviate the potential acidic metabolic burden on the circulatory and urinary systems due to ketogenic diets. For example, additives, such as potassium citrate may be incorporated into the pet food compositions disclosed herein to reduce kidney-stone incidence or formation. Potassium citrate may provide benefits to urinary health including dissolution of uroliths. It is noted that the incorporation of potassium citrate requires a non-obvious balancing of various factors/variables including, but not limited to, cations and anions, residual potassium, the resultant urinary pH, overall palatability, or combinations thereof. Nevertheless, in some embodiments, the pet food composition may contain potassium citrate in an amount sufficient to preferably provide between 1 to 6 Milliequivalents (mEq) potassium citrate per kilogram metabolic bodyweight (1 to 6 mEq K3Citrate/kg0.75).

Sources of amino acids can include 1-Tryptophan, Taurine, Histidine, Carnosine, Alanine, Cysteine, Arginine, Methionine, Tryptophan, Lysine, Asparagine, Aspartic acid, Phenylalanine, Valine, Threonine, Isoleucine, Histidine, Leucine, Glycine, Glutamine, Tyrosine, Homocysteine, Ornithine, Citruline, Glutamic acid, Proline, and/or Serine.

Sources of carotenoids may include lutein, astaxanthin, zeaxanthin, bixin, lycopene, and/or beta-carotene. Sources of antioxidant ingredients can include tocopherols (vitamin E), vitamin C, vitamin A, plant-derived materials, carotenoids (described above), selenium, and/or CoQ10 (Coenzyme Q10). Sources of fatty acid ingredients can include arachidonic acid, alpha-linoleic acid, gamma linolenic acid, linoleic acid, eicosapentanoic acid (EPA), docosahexanoic acid (DHA), and/or fish oils as a source of EPA and/or DHA.

Sources of glucose mimetics can include glucose anti-metabolites including 2-deoxy-D-glucose, 5-thio-D-glucose, 3-O-methylglucose, anhydrosugars including 1,5-anhydro-D-glucitol, 2,5-anhydro-D-glucitol, and 2,5-anhydro-D-mannitol, mannoheptulose, and/or avocado extract comprising mannoheptulose.

Still other ingredients may include beef broth, brewers dried yeast, egg, egg product, flax meal, DL methionine, amino acids, leucine, lysine, arginine, cysteine, cystine, aspartic acid, polyphosphates, sodium pyrophosphate, sodium tripolyphosphate; zinc chloride, copper gluconate, stannous chloride, stannous fluoride, sodium fluoride, triclosan, glucosamine hydrochloride, chondroitin sulfate, green lipped mussel, blue lipped mussel, methyl sulfonyl methane (MSM), boron, boric acid, phytoestrogens, phytoandrogens, genistein, diadzein, L-carnitine, chromium picolinate, chromium tripicolinate, chromium nicotinate, acid/base modifiers, potassium citrate, potassium chloride, calcium carbonate, calcium chloride, sodium bisulfate; eucalyptus, lavender, peppermint, plasticizers, colorants, flavorants, sweeteners, buffering agents, slip aids, carriers, pH adjusting agents, natural ingredients, stabilizers, biological additives such as enzymes (including proteases and lipases), chemical additives, coolants, chelants, denaturants, drug astringents, emulsifiers, external analgesics, fragrance compounds, humectants, opacifying agents (such as zinc oxide and titanium dioxide), anti-foaming agents (such as silicone), preservatives (such as butylated hydroxytoluene (BHT) and butylated hydroxyanisole (BHA), propyl gallate, benzalkonium chloride, EDTA, benzyl alcohol, potassium sorbate, parabens and mixtures thereof), reducing agents, solvents, hydrotropes, solubilizing agents, suspending agents (non-surfactant), solvents, viscosity increasing agents (aqueous and non-aqueous), sequestrants, and/or keratolytics.

Suitable probiotics may include one or more bacterial probiotic microorganisms suitable for pet consumption and effective for improving the microbial balance in the pet gastrointestinal tract or for other benefits, such as disease or condition relief or prophylaxis, to the pet. In some embodiments, the probiotic component may be selected from bacteria, yeast, or microorganism of the genera Bacillus, Bacteroides, Bifidobacterium, Enterococcus (e.g., Enterococcus faecium DSM 10663 and Enterococcus faecium SF68), Lactobacillus, Leuconostroc, Saccharomyces, Candida, Streptococcus, and mixtures of any thereof. In other embodiments, the probiotic may be selected from the genera Bifidobacterium, Lactobacillus, and combinations thereof. Those of the genera Bacillus may form spores. In further embodiments, the probiotic does not form a spore. Non-limiting examples of lactic acid bacteria suitable for use herein include strains of Streptococcus lactis, Streptococcus cremoris, Streptococcus diacetylactis, Streptococcus thermophilus, Lactobacillus bulgaricus, Lactobacillus acidophilus (e.g., Lactobacillus acidophilus strain DSM 13241), Lactobacillus helveticus, Lactobacillus bifidus, Lactobacillus casei, Lactobacillus lactis, Lactobacillus plantarum, Lactobacillus rhamnosus, Lactobacillus delbrukii, Lactobacillus thermophilus, Lactobacillus fermentii, Lactobacillus salvarius, Lactobacillus reuteri, Bifidobacterium longum, Bifidobacterium infantis, Bifidobacterium bifidum, Bifidobacterium animalis, Bifidobacterium pseudolongum, and Pediococcus cerevisiae, or mixtures of any thereof. In specific embodiments, the probiotic-enriched coating may comprise the bacterial strain Bifidobacterium animalis AHC7 NCIMB 41199.

In certain embodiments, the pet food composition comprises moisture. The moisture may be present at various amounts or concentrations. In one embodiment, moisture may be present in an amount of from about 3 to about 20 wt.%, based on the total weight of the pet food composition. For example, moisture may be present in an amount of about 3 wt.%, about 5 wt.%, about 5.5 wt.%, about 6 wt.%, about 6.5 wt.%, about 7 wt.%, about 7.5 wt.%, about 8 wt.%, about 8.5 wt.%, about 9 wt.%, about 9.5 wt.%, about 10 wt.%, about 10.5 wt.%, about 11 wt.%, about 11.5 wt.%, about 12 wt.%, about 12.5 wt.%, about 13 wt.%, about 13.5 wt.%, about 14 wt.%, about 14.5 wt.%, or about 15 wt.%, based on the total weight of the pet food composition. In another example, moisture may be present in an amount of from about 4% to about 12%, about 5% to about 11%, about 6% to about 10%, based on the total weight of the pet food composition. In certain embodiments, moisture is present in an amount of about 6% to about 10%, based on the total weight of the pet food composition.

As used herein, the term “kibble” includes a particulate pellet like component of animal feeds, such as dog and cat feeds, typically having a moisture, or water, content of less than 12% by weight. Kibbles may range in texture from hard to soft. Kibbles may range in internal structure from expanded to dense. Kibbles may be formed by an extrusion process. In non-limiting examples, a kibble can be formed from a core and a coating to form a kibble that is coated, also called a coated kibble. It should be understood that when the term “kibble” is used, it can refer to an uncoated kibble or a coated kibble.

Some embodiments of the present invention comprise a protein source. The protein source, or protein ingredient, can comprise chicken meals, chicken, chicken by-product meals, lamb, lamb meals, turkey, turkey meals, beef, beef by-products, viscera, fish meal, enterals, kangaroo, white fish, venison, soybean meal, soy protein isolate, soy protein concentrate, corn gluten meal, corn protein concentrate, distillers dried grains, and/or distillers dried grains solubles and single-cell proteins, for example yeast, algae, and/or bacteria cultures.

As noted above, the pet food composition may include a carbohydrate source. carbohydrate source may be selected from cereals, grains, corn, wheat, rice, oats, corn grits, sorghum, grain sorghum/milo, wheat bran, oat bran, amaranth, Durum, semolina, and a combination of two or more thereof.

The term “carbohydrate” can include polysaccharides (e.g., starches and dextrins) and sugars (e.g., sucrose, lactose, maltose, glucose, and fructose) that are metabolized for energy when hydrolyzed. Carbohydrates content of foods can be determined by any number of methods known by those of skill in the art.

Generally, carbohydrate percentage can be calculated as nitrogen free extract (“NFE”), which can be calculated as follows: NFE=100%-(moisture %)-(protein %)-(fat %)-(ash %)-(crude fiber %). The amount of carbohydrate, e.g., calculated as NFE, present in the composition may be an amount up to 90 wt.%, based on the total weight of the pet composition on a dry matter basis. In some embodiments, the carbohydrate is present in the pet food composition in an amount up to about 30 wt.%, an amount up to about 20 wt.%, an amount up to about 10 wt.%, an amount up to about 5 wt.%, an amount up to about 4 wt.%, an amount up to about 3 wt.%, an amount up to about 2 wt.%, an amount up to about 1 wt.%; from about 1 to about 30 wt.%, about 1 to about 20 wt.%, about 1 to about 10 wt.%, about 1 to about 5 wt.%, about 1 to about 4 wt.%, about 1 to about 3 wt.%, about 1 to about 2 wt.%; from about 3 to about 30 wt.%, about 3 to about 20 wt.%, about 3 to about 10 wt.%, about 3 to about 5 wt.%; from about 5 to about 30 wt.%, about 5 to about 20 wt.%, about 5 to about 10 wt.%; from about 8 to about 30 wt.%, about 8 to about 20 wt.%, about 8 to about 10 wt.%; from about 10 to about 30 wt.%, about 10 to about 20 wt.%, about 10 to about 15 wt.%, based on the total weight of the pet composition on a dry matter basis. In further embodiments, the carbohydrate is present in the pet food composition in an amount from about 10 to about 90 wt.%, about 10 to about 70 wt.%, about 10 to about 50 wt.%, about 10 to about 40 weight%, about 10 to about 30 wt.%, about 10 to about 20 wt.%; about 20 to about 90 wt.%, about 20 to about 70 wt.%, about 20 to about 50 wt.%, about 20 to about 40 weight%; about 30 to about 90 wt.%, about 30 to about 70 wt.%, about 30 to about 50 wt.%, about 30 to about 40 weight%; about 50 to about 90 wt.%, about 50 to about 70 wt.%; or about 70 to about 90 wt.%, based on the total weight of the pet composition on a dry matter basis.

In certain embodiments, the pet food composition comprises moisture. The moisture may be present at various amounts or concentrations. In one embodiment, moisture may be present in an amount of from about 3 to about 20 wt.%, based on the total weight of the pet food composition. For example, moisture may be present in an amount of about 3 wt.%, about 5 wt.%, about 5.5 wt.%, about 6 wt.%, about 6.5 wt.%, about 7 wt.%, about 7.5 wt.%, about 8 wt.%, about 8.5 wt.%, about 9 wt.%, about 9.5 wt.%, about 10 wt.%, about 10.5 wt.%, about 11 wt.%, about 11.5 wt.%, about 12 wt.%, about 12.5 wt.%, about 13 wt.%, about 13.5 wt.%, about 14 wt.%, about 14.5 wt.%, or about 15 wt.%, based on the total weight of the pet food composition. In another example, moisture may be present in an amount of from about 6% to about 12%, about 9% to about 13%, about 9% to about 11%, or about 9% to about 13%, based on the total weight of the pet food composition. In certain embodiments, moisture is present in an amount of about 5% to about 12%, about 6% to about 11%, or about 7% to about 10.0%, based on the total weight of the pet food composition. In further embodiments, moisture is present in an amount of about 65% to about 85%, about 60% to about 80%, or about 60% to about 75%, based on the total weight of the pet food composition.

In some embodiments, the pet food compositions disclosed herein may be in the form of a stand-alone pet food, as a supplement to pet food, as a pet food treat, or the like.

The pet food compositions described herein may be produced by various methods to achieve the desired pet food composition or desired form for the pet food composition. For example, dry food may be baked or extruded, then cut into individual shaped portions, such as kibbles. In some embodiments, the pet food composition may be prepared in a canned or wet form using conventional food preparation processes known to those of ordinary skill in the art. Typically, ground animal proteinaceous tissues are mixed with the other ingredients, such as cereal grains, suitable carbohydrate sources, fats, oils, and balancing ingredients, including special purpose additives such as vitamin and mineral mixtures, inorganic salts, cellulose, beet pulp and the like, and water in an amount sufficient for processing. The ingredients are mixed in a vessel suitable for heating while blending the components. Heating the mixture is carried out using any suitable manner, for example, direct steam injection or using a vessel fitted with a heat exchanger. The pet food compositions and food products of the present disclosure can also be added to or combined with food compositions before, during, or after their preparation.

In some embodiments, the food products may be prepared in a dry form using conventional processes known to those of ordinary skill in the art. Typically, dry ingredients, including dried animal protein, plant protein, grains and the like are ground and mixed together. Liquid or moist ingredients, including fats, oils, water, animal protein, and the like are added combined with the dry materials. The specific formulation, order of addition, combination, and methods and equipment used to combine the various ingredients can be selected from those known in the art. For example, in certain embodiments, the resulting mixture is process into kibbles or similar dry pieces, which are formed using an extrusion process in which the mixture of dry and wet ingredients is subjected to mechanical work at high pressure and temperature, forced through small openings or apertures, and cut off into the kibbles, e.g., with a rotating knife. The resulting kibble can be dried and optionally coated with one or more topical coatings comprising, e.g., flavors, fats, oils, powdered ingredients, and the like. Kibbles may also be prepared from dough by baking, rather than extrusion, in which the dough is placed into a mold before dry-heat processing.

In preparing a composition, any ingredient generally may be incorporated into the composition during the processing of the formulation, e.g., during and/or after mixing of the other components of the composition. Distribution of these components into the composition can be accomplished by conventional means. In certain embodiments, ground animal and/or poultry proteinaceous tissues are mixed with other ingredients, including nutritional balancing agents, inorganic salts, and may further include cellulose, beet pulp, bulking agents and the like, along with sufficient water for processing.

In some embodiments, the present invention provides a pet food composition comprising: from about 10 wt.% to about 50 wt.% protein; from about 10 wt.% to about 40 wt.% fat; and up to about 20 wt.% fiber; wherein the pet food composition has a peak force of from about 5 kg to about 11 kg.

Without being limited to any particular theory, the inventors believe that certain pet food compositions having particular amounts and ratios of protein and fat limit the expansion capacity of the starch/carbohydrate matrix, while simultaneously providing a lubricating effect and a plasticizing effect to achieve a preferably dense pet food composition with a low peak force texture. Additionally, certain embodiments of the pet food composition advantageously have particular fibers in certain amounts that contribute to the structure of the pet food composition in an extruded kibble form and provide an enhanced texture.

In some embodiments, the pet food composition further comprises a hydrolyzed protein. In certain embodiments, the hydrolyzed protein comprises a protein source selected from: chicken; fish; soy; and a combination of two or more thereof.

In some embodiments, the pet food composition further comprises lactic acid. In some embodiments, the pet food composition comprises from about 0.1 wt.% to about 3 wt.% lactic acid. In certain embodiments, the pet food composition comprises from about 0.25 wt.% to about 2.5 wt.% lactic acid. In other embodiments, the pet food composition comprises from about 0.5 wt.% to about 2 wt.% lactic acid. In further embodiments, the pet food composition comprises from about 0.75 wt.% to about 1.75 wt.% lactic acid. In some embodiments, the pet food composition comprises from about 1 wt.% to about 1.5 wt.% lactic acid. In some embodiments, the pet food composition comprises about 1.2 wt.% lactic acid.

In some embodiments, the pet food composition has a density of greater than about 25 lbs/ft³. In some embodiments, the pet food composition has a density of from about 25 lbs/ft³ to about 38 lbs/ft³, optionally about 26 lbs/ft³, about 27 lbs/ft³, about 28 lbs/ft³, about 29 lbs/ft³, about 30 lbs/ft³, about 31 lbs/ft³, about 32 lbs/ft³, about 33 lbs/ft³, about 34 lbs/ft³, about 35 lbs/ft³, about 36 lbs/ft³, about 37 lbs/ft³, or about 38 lbs/ft³.

In some embodiments, the fiber comprises a prebiotic source. In some embodiments, the source of prebiotic is selected from: apple; banana; flaxseed; chicory root; raw oats; and a combination of two or more thereof.

Certain embodiments of the present invention provide a fiber comprising a bulking fiber.

In further embodiments, the pet food composition further comprising an amino acid.

Yet other embodiments provide pet food compositions in the form of a kibble. In some embodiments, the pet food composition is in the form of a multi-layer kibble. In other embodiments, the multi-layer kibble comprises a coating. In still further embodiments, the coating comprises a palatant.

In some embodiments, the pet food composition is substantially free of humectants.

In some embodiments, the fiber comprises a fibrillary network. The fibrillary network may comprise plant-based and/or fungus based fibers and/or fibrillary networks. The plant-based and/or fungus based fibers may comprise soluble fibers and/or insoluble fibers. The fibrillary network may, additionally or alternatively, comprise a protein-fiber network. In certain embodiments, the fibrillary network is formed from at least plant-based fibers interacting with a denatured protein. Without being limited to any particular theory, the fibrillary network may be promoted and/or enhanced during the extrusion process of the pet food composition. In some embodiments, the fibrillary network comprises pores. In some embodiments, the pet food composition has a porosity effective to absorb fat from the coating.

The pet food compositions of the present invention can be provided in any shape or form. In some embodiments, the pet food composition is in the form of a kibble that has a length of from about 3 mm to about 10 mm. In some embodiments, the kibble has a width of from about 5 mm to about 20 mm. In other embodiments the kibble can be provided in a variety of shapes, for example, round; oval; ellipse; triangular; square; diamond; spherical, and the like.

In some embodiments, the pet food composition has a deformation distance of from about 1 mm to about 3 mm.

Other embodiments of the present invention provide methods for: increasing caloric intake; increasing body weight; improving quality of life; reducing atrophy (e.g., muscular atrophy); enhancing immunity; and/or reducing bone demineralization, in a companion animal, comprising administering to a companion animal in need thereof, a pet food composition comprising: from about 10 wt.% to about 50 wt.% protein; from about 10 wt.% to about 40 wt.% fat; and up to about 20 wt.% fiber; wherein the pet food composition has a peak force of from about 5 kg to about 11 kg. In some embodiments, the companion animal is suffering from: cancer; renal dysfunction; and/or liver dysfunction.

Still further embodiments of the present invention provide for the use of anyone of the compositions described herein for increasing caloric intake in a companion animal in need thereof.

Embodiments of the present invention will now be further described by way of the following, non-limiting, examples.

### EXAMPLES

### Example 1

An exemplary composition of the present invention is described below in Table 1.

TABLE 1

| Ingredient | Wt.% |
|---|---|
| Grains | 30-55 |
| Meats | 10-40 |
| Fats | 10-25 |
| Flavors | 1-5 |
| Egg | 1-5 |
| Fibers (Prebiotics) | 1-5 |
| Minerals | 0.5-3 |
| Natural Preservative | 0.5-2 |
| Vitamins | 0.1-1 |
| Amino Acids | 0.1-1 |
| Antioxidant | 0.01-0.1 |

The exemplary composition of the present invention, described in Table 1 (above), can be prepared in accordance with methods generally known to those skilled in the art of manufacturing pet food compositions.

### Example 2

Two non-limiting exemplary pet food compositions (Example Compositions I and II) and eleven comparative compositions, which were all in the form of kibbles, were obtained. The formulation for Example Compositions I and II (Ex. I and II) and Comparative Compositions 1, 4, 7, 8, 9, 10, and 10 (Comps. 1, 4, 7, 8, 9, 10, and 10) are shown in Table 2. Comparative Compositions 2, 3, 5, and 6 were commercial products. The list of ingredients for Comparative Compositions 2, 3, 5, and 6 are provided after Table 2.

TABLE 2

| Ingredient | Ex. I | Ex. II | Comp. 1 | Comp. 4 | Comp. 7 | Comp. 8 | Comp. 9 | Comp. 10 | Comp. 11 |
|---|---|---|---|---|---|---|---|---|---|
| | Wt.% | | | | | | | | |
| Wheat (whole) | 14-23 | 8-15 | 8-17 | | | | 3-9 | | 22-35 |
| Sorghum, whole | | | 8-17 | | | | | | |
| Corn, yellow, whole | | | 8-17 | 4-9 | | 8.5-17.5 | | 5-10 | |
| Oat Groats and/or Barley Pearled | 3-6.5 | 5-10 | 8-17 | 5-11 | | | 8-15 | 11-20 | |
| Carrot Dices | 0.2-1 | 0.2-0.7 | | | | | | | |
| Rice (Brown Rice and/or Brewers Rice) | 3-8 | 2-6.5 | 1.5-5.5 | 9-18 | 34-46 | 16-27 | 9-18 | 8-17 | 1-4.5 |
| Rice Protein or Pea Protein | | | | 4-9 | 10-19 | | | | |
| Soybean, meal | 4-9 | 2-5.5 | 3-8 | | | | | | |
| Egg Dried pelleted | 1.5-5 | 4-9 | | | | 3-8 | 4-9 | 4-9 | |
| Wheat Gluten and/or Corn Gluten | 8-12 | 16-31 | 8-17 | 16-27 | | 16-27 | 8-17 | 11-20 | 22-34 |
| Dried Chicken and/or Chicken Meal | 3-8 | 9-17 | 1-4.5 | 12-22 | | 12-22 | 11-20 | 18-29 | 6-14 |
| Fresh Chicken | 10-19 | | 10-19 | | | | 10-19 | | 8-17 |
| Chicken Liver and/or Chicken Heart | 6-11 | 3-8 | 1.5-5.5 | | 22-35 | | | | 0.8-4 |
| Chicken Fat Refined | 7-11 | 10-15 | 2-7 | 6-13 | | 7-16 | 6-14 | | 8-17 |
| Pork Fat, Choice White Grease | | | | | | | | 7-16 | |
| Fish oil | 1-3.5 | 1-3.5 | | 0.5-2.2 | | | 0.5-2.2 | | 0.3-1.7 |
| Coconut Oil | 1-3.5 | 1-3.5 | | | 1-4.5 | | | | |
| Soybean Oil | | | 1-4.5 | | 1.5-6 | 1-5 | | | 0.2-1.5 |
| Palatant and/or Natural Flavor | 2-6.5 | 2-5 | 0.5-2 | 1-4.5 | | 1.5-5.5 | 1.5-5.5 | 1-4.5 | |
| Amino Acid (Taurine, Tryptophan, L-Arginine, Lysine hydrochloride, Methionine, and/or Threonine) | 0.2-0.7 | 0.6-1.5 | 0.01-0.1 | 1-3.5 | 0.7-2.5 | 0.7-2.5 | 0.8-3 | 0.5-2.2 | 0.1-0.4 |
| Choline chloride | 0.05-0.4 | 0.3-1 | 0.1-0.9 | 0.1-0.9 | 0.1-0.8 | 0.4-1.2 | 0.1-0.9 | 0.2-1.4 | 0.1-0.9 |
| Carnitine, l, | 0.01-0.1 | 0.2-0.9 | | | | | | | |
| Magnesium oxide | | 0.01-0.1 | | | | | 0.01-0.1 | 0.01-0.1 | |
| Calcium carbonate, Calcium sulfate, and/or Dicalcium phosphate | 0.5-2 | 0.5-3 | 0.3-1.7 | 0.01-0.3 | 1-4.5 | 0.1-0.4 | 0.7-2.5 | 0.3-1.7 | 0.7-2.5 |
| Vitamin Premix (including Vitamin E), Mineral Premix, and/or Antioxidant | 0.2-0.7 | 0.2-0.9 | 0.2-0.8 | 0.1-0.7 | 0.2-0.8 | 0.2-0.7 | 0.2-0.9 | 0.4-1.5 | 0.2-0.7 |
| Flax seed whole brown | 0.4-1 | 0.4-1 | 0.4-1 | 0.7-2.5 | | | 0.7-2.5 | | |
| Beet Pulp | 0.4-1 | 0.4-1 | 1.5-4 | 1.5-4 | | | | 0.5-2 | 1.5-4 |
| Oat Fiber, Psyllium Husks, or Cellulose | | | 0.01-0.1 | 0.7-2.5 | 2-5 | 0.5-2 | 0.01-0.1 | 0.1-0.4 | 0.01-0.1 |
| Activbiome Fibers (blend) | 1.5-4 | 1.5-4 | | 3.5-8.5 | | | | | |
| Dried Pumpkin | | | | 0.2-1.4 | | | | | |
| Fructooligosaccharides | | | | 0.2-1.4 | | 0.2-1.4 | | 0.2-1.4 | |
| Lactic acid | 0.5-2 | 0.5-2 | 0.5-2 | 0.5-2 | 0.5-2 | 0.5-2 | 0.5-2 | 0.5-2 | 0.5-2 |
| Glyceryl Monostearate | | | | | 0.3-1.7 | | | | |
| Sodium Tripolyphosphate | | | | | | | 0.2-0.7 | | |
| Sodium Chloride | 0.2-0.7 | 0.01-0.4 | 0.2-0.7 | 0.01-0.4 | 0.01-0.4 | 0.2-0.7 | 0.01-0.1 | 0.01-0.4 | 0.2-0.8 |
| Potassium chloride and/or Potassium citrate | 0.3-1.5 | 0.5-2 | 0.2-1.4 | 0.2-1.4 | 0.5-2 | 0.4-1.5 | 0.4-1.5 | 0.5-2 | 0.4-1.5 |

Comparative Composition 2, had the following ingredients:

Brewers rice, chicken by-product meal, oat groats, wheat, corn gluten meal, chicken fat, natural flavors, dried plain beet pulp, fish oil, calcium carbonate, vegetable oil, potassium chloride, salt, monocalcium phosphate, choline chloride, hydrolyzed yeast, vitamins [DL-alpha tocopherol acetate (source of vitamin E), L-ascorbyl-2-polyphosphate (source of vitamin C), biotin, D-calcium pantothenate, vitamin A acetate, niacin supplement, pyridoxine hydrochloride (vitamin B6), thiamine mononitrate (vitamin B1), vitamin B12 supplement, riboflavin supplement, vitamin D3 supplement, folic acid], L-lysine, trace minerals (zinc proteinate, zinc oxide, ferrous sulfate, manganese proteinate, manganous oxide, copper sulfate, calcium iodate, sodium selenite, copper proteinate), magnesium oxide, rosemary extract, preserved with mixed tocopherols and citric acid.

Comparative Composition 3 had the following ingredients:

Deboned Chicken, Chicken Meal, Brown Rice, Barley, Oatmeal, Pea Starch, Flaxseed (source of Omega 3 and 6 Fatty Acids), Chicken Fat (preserved with Mixed Tocopherols), Dried Tomato Pomace, Natural Flavor, Peas, Pea Protein, Salt, Potassium Chloride, Dehydrated Alfalfa Meal, Potatoes, Dried Chicory Root, Pea Fiber, Alfalfa Nutrient Concentrate, Calcium Carbonate, Choline Chloride, DL-Methionine, Preserved with Mixed Tocopherols, Dicalcium Phosphate, Sweet Potatoes, Carrots, Garlic, Zinc Amino Acid Chelate, Zinc Sulfate, Vegetable Juice for Color, Ferrous Sulfate, Vitamin E Supplement, Iron Amino Acid Chelate, Blueberries, Cranberries, Barley Grass, Parsley, Turmeric, Droed Kelp, Yucca Schidigera Extract, Niacin (Vitamin B3), Glucosamine Hydrochloride, Calcium Pantothenate (Vitamin B5), Copper Sulfate, Biotin (Vitamin B7), L-Ascorbyl-2-Polyphosphate (source of Vitamin C), L-Lysine, L-Carnitine, Vitamin A Supplement, Copper Amino Acid Chelate, Manganese Sulfate, Taurine, Manganese Amino Acid Chelate, Thiamine Mononitrate (Vitamin B1), Riboflavin (Vitamin B2), Vitamin D3 Supplement, Vitamin B12 Supplement, Pyridoxine Hydrochloride (Vitamin B6), Calcium Iodate, Dried Yeast, Dried Enterococcus faecium fermentation product, Dried Lactobacillus acidophilus fermentation product, Dried Aspergillus niger fermentation extract, Dried Trichoderma longibrachiatum fermentation extract, Dried Bacillus subtilis fermentation extract, Folic Acid (Vitamin B9), Sodium Selenite, Oil of Rosemary.

Comparative Composition 5 had the following ingredients:

Chicken, rice, corn gluten meal, poultry by-product meal, wheat flour, dried egg product, beef fat preserved with mixed-tocopherols, soy protein concentrate, natural flavor, fish meal, inulin, potassium chloride, phosphoric acid, calcium carbonate, salt, caramel color, choline chloride, VITAMINS Vitamin E supplement, niacin Milamin B-3), Vitamin A supplement, calcium pantothenate (Vitamin B-5), thiamine mononitrate (Vitamin B-1), riboflavin Supplement (Vitamin B-2), Vitamin B-12 supplement, pyridoxine hydrochloride (Vitamin B-6), folic acid (Vitamin B-9), Vitamin D-3 supplement, biotin (Vitamin B-7), menadione sodium bisulfite complex (Vitamin K), taurine. MINERALS (zinc sulfate, ferrous sulfate, manganese sulfate, copper sulfate, calcium iodate, sodium selenite), L-Lysine monohydrochloride, dried Bacillus coagulans fermentation product.

Comparative Composition 6 had the following ingredients:

Deboned Chicken, Chicken Meal, Brown Rice, Barley, Oatmeal, Pea Protein, Peas, Chicken Fat (preserved with Mixed Tocopherols), Dried Egg Product, Menhaden Fish Meal, Pea Fiber, Natural Flavor, Flaxseed (source of Omega 6 Fatty Acids), Calcium Chloride, Fish Oil (source of Omega 3 Fatty Acids), DL-Methionine, Calcium Sulfate, Choline Chloride, Potatoes, Potassium Chloride, Dehydrated Alfalfa Meal, Dried Chicory Root, Alfalfa Nutrient Concentrate, Taurine, Calcium Carbonate, Salt, Cranberries, preserved with Mixed Tocopherols, Sweet Potatoes, Carrots, Vegetable Juice for color, Ferrous Sulfate, Niacin (Vitamin B3), Iron Amino Acid Chelate, Zinc Amino Acid Chelate, Zinc Sulfate, Vitamin E Supplement, Blueberries, Barley Grass, Parsley, Turmeric, Dried Kelp, Yucca Schidigira Extract, Copper Sulfate, Thiamine Mononitrate (Vitamin B1), Copper Amino Acid Chelate, L-Ascorbyl-2-Polyphosphate (source of Vitamin C), L-Lysine, Biotin (Vitamin B7), L-Carnitine, Vitamin A Supplement, Manganese Sulfate, Manganese Amino Acid Chelate, Pyridoxine Hydrochloride (Vitamin B6), Calcium Pantothenate (Vitamin B5), Riboflavin (Vitamin B2), Vitamin D3 Supplement, Vitamin B12 Supplement, Folic Acid (Vitamin B9), Dried Yeast, Dried Enterococcus faecium fermentation product, Dried Lactobacillus acidophilus fermentation product, Dried Aspergillus niger fermentation extract, Dried Trichoderma longibrachiatum fermentation extract, Dried Bacillus subtilis fermentation extract, Calcium Iodate, Sodium Selenite, Oil of Rosemary.

### Example 3

Palatability tests were conducted using methods commonly used in the pet food industry called a 2-pan palatability test. The palatability testing procedure consists of offering a panel of 25 pets a choice of two foods for a specified period of time and comparing the amounts (intake) of each food eaten to determine how much of each product a pet eats and the one that is eaten in a greater amount is more palatable. The foods are named as control (Comp. Ex. 1-3) and test (Ex. I). The preference for either Comp. Ex. 1-3 or Ex. I was determined by the total consumption (preference for the test indicates the pets ate more of the test food). Additionally, intake levels are statistically analyzed to determine if there is a statistical difference in intake levels to indicate whether one food was liked better. The protocol is a 2 day/2 food-pan palatability test with 25 pets. The results of these palatability tests are described below in Table 3.

TABLE 3

| Study # | Preference (%) for Ex. I | Preference (%) for Comparative Foods | P value |
|---|---|---|---|
| 1 | 84 | 12 (Comp. Ex. 1) | 0.0001 |
| 2 | 88 | 12 (Comp. Ex. 2) | 0.0001 |
| 3 | 84 | 12 (Comp. Ex. 3) | 0.0002 |

As described in Table 3 (above), an exemplary composition of the present invention was tested against three (3) different commercial pet foods (Comp. Ex. 1-3), and the preference was reported. The data described in Table 2 demonstrates that the dogs had a significantly greater preference for the exemplary composition of the present invention (Ex. I) against each of the commercial foods (Comp. Ex. 1-3).

### Example 4

Dogs with cancer were recruited by veterinarians in private veterinary practices. The veterinarians provided the food and instructions on how much food and calories to feed based on the dog’s ideal body weight. Dog owners were provided kitchen scales and instructions on how to weigh their dog’s original food and the new exemplary composition. Dog owners weighed their original food offered to the dog and the amount that was not eaten for a representative meal and then recorded how many meals were fed per day. The amount of feed eaten was calculated as Amount offered, g - Amount returned, g = Amount eaten, g. Using the calorie content of the original food, calories per day were calculated as grams eaten/day x kcal/g food = kcal eaten/day. The dog owners were then instructed to transition their dog to the exemplary food. The same process was used as described above to determine amount of exemplary food eaten and calories consumed per day.

Seventy percent (70%) of dogs with cancer ate up to two hundred fifty percent (250%) more calories of an exemplary composition of the present invention (Ex. I) compared with their original food and only thirty percent (30%) of the dogs at the same or less calories. The results of this evaluation are reported in Table 4 (below). In addition, the exemplary composition of the present invention (Ex. I) created excellent stool quality and the dogs did not have vomiting issues as a result of eating the food. Dogs transitioned successfully to the inventive composition of the present invention (Ex. I) and did not have issues due to high fat levels (no pancreatitis).

TABLE 4

| | | | |
|---|---|---|---|
| Eating Parameter | Comp. Ex. 4 | Ex. I | P value |
| Eating Enthusiasm on a scale from 1 - 7 with 1 being lowest and 7 as highest | Mean 5.9 of 7 Std Err 0.2 n=31 | Mean 6.6 out of 7 Std Err 0.2 n=31 | P < 0.05 |
| Calories eaten, kcal/day | Mean 927 kcal/day Std Err 105 n=27 | Mean 1267 kcal/day Std Err 160 n=19 | P < 0.05 |
| Calories eaten, kcal/kg body weight^{0.75} | Mean 81 kcal/kg^{0.75} Std Err 6 n=27 | Mean 109 kcal/kg^{0.75} Std Err 7 n=19 | P < 0.05 |

In addition, the dog owners reported that their dog’s strength, vitality and energy level were excellent. They also reported their dogs maintained high levels related to being playful, doing their favorite activities, and interacting with people while feeding the inventive composition of the present invention for 28 days.

### Example 5

The texture of an exemplary kibble of the present invention (Ex. I) was evaluated using a TA-XT plus Texture Analyzer. Kibbles are individually placed as centered as possible under a probe to compress the kibble. Once the trigger force is attained, the probe proceeds to compress the sample to the specified distance. During this time, the force is seen as a series of fluctuations as major fracture of the sample occurs, followed by a smoother and lower force profile as the sample breaks down into much smaller pieces. Once tests have been performed (usually 25 replicates), values of particular interest for sample analysis can be automatically obtained by a MACRO. Typically for this test, the peak force and deformation distance are recorded. The results of these evaluations are described below in Table 5.

TABLE 5

| Measurements | Foods | | | |
|---|---|---|---|---|
| | Ex. I | Comp. Ex. 1 | Comp. Ex. 2 | Comp. Ex. 3 |
| Peak force (Kg) | 5-11 | 12.79 | 15.51 | 10.28 |
| Deformation distance (mm) | 1-3 | 1.03 | 1.47 | 0.87 |

The data in Table 5 (above) demonstrates that the exemplary kibble of the present invention (Ex. I) required less force to break the kibble and the deformation point is higher than the comparative kibbles (Comp. Ex. 1-3). In addition, the inventive kibble and the comparative kibbles were evaluated by touch and the inventive kibble (Ex. I) was deemed to feel softer than the comparative kibbles (Comp. Ex. 1-3). This data was corroborated by the texture measurements described in Table 5 (above).

### Example 6

Dogs with cancer often lose weight and studies have shown that when weight loss and underweight status are present, it can affect survival in dogs with cancer. In a study with dogs with cancer, 65% of dogs had a positive impact on their body weight when fed an exemplary composition of the present invention, 25% of dogs had no change in their body weight trend and only 10% of dogs lost weight during the study. The results are described below in Table 6. Moreover, the positive impact of the highly palatable food on their body weight during the study was much higher (4.4% and 4.5%) compared to the impact of the food on the ‘no change’ group or ‘decreased weight’ group (-1% and 1.1%).

TABLE 6

| Trend in Body Weight Change during study (Enrollment day to Day 28) | Number of Dogs (% of dogs) | Avg Body weight (BW) at Enrollment (lb) | Avg BW at Day 28 (lb) | Avg % Change in BW |
|---|---|---|---|---|
| Increased weight | 10 (50%) | 54.8 | 57.2 | 4.4 |
| Losing weight before study then gained weight on highly palatable food | 2 (10%) | 73.7 | 77 | 4.5 |
| Losing weight before study then remained at stable weight on highly palatable food | 1 (5%) | 50.4 | 50.4 | 0 |
| Had stable weight but lost weight on the highly palatable food | 2 (10%) | 58.1 | 57.5 | -1 |
| No change in body weight trend | 5 (25%) | 72.1 | 72.9 | 1.1 |

### Example 7

Another exemplary composition of the present invention is described below in Table 7.

TABLE 7

| Ingredient | Wt.% |
|---|---|
| Grains | 30-75 |
| Meats | 10-40 |
| Fats | 10-25 |
| Flavors | 1-5 |
| Egg | 1-5 |
| Fibers (Prebiotics) | 1-5 |
| Minerals | 0.5-3 |
| Natural Preservative | 0.5-2 |
| Vitamins | 0.1-1 |
| Amino Acids | 0.1-1 |
| Antioxidant | 0.01-0.1 |

The exemplary composition of the present invention described in Table 7 (above) can be prepared in accordance with methods generally known to those skilled in the art of manufacturing pet food compositions.

### Example 8

The texture of an exemplary kibble of the present invention (Ex. II) was evaluated using a TA-XT plus Texture Analyzer. Kibbles were individually placed as centered as possible under a probe to compress the kibble. Once the trigger force was attained, the probe proceeded to compress the sample to the specified distance. During this time, the force is seen as a series of fluctuations as major fracture of the sample occurs, followed by a smoother and lower force profile as the sample breaks down into much smaller pieces. Once tests have been performed (usually 25 replicates), values of particular interest for sample analysis can be automatically obtained by a MACRO. Typically for this test, the peak force and deformation distance are recorded. The results of these evaluations are described below in Table 8.

TABLE 8

| Measurements | Foods | | | | | | | | |
|---|---|---|---|---|---|---|---|---|---|
| | Ex. II | Comp. Ex. 4 | Comp. Ex. 5 | Comp. Ex. 6 | Comp. Ex. 7 | Comp. Ex. 8 | Comp. Ex. 9 | Comp. Ex. 10 | Comp. Ex. 11 |
| Peak force (Kg) | 2.7-4.7 | 11.16 | 7.18 | 4.94 | 8.31 | 6.74 | 6.23 | 9.02 | 8.23 |
| Deformation distance (mm) | 0.5-0.75 | 0.85 | 0.74 | 0.56 | 0.76 | 0.69 | 0.59 | 0.71 | 0.85 |

The data in Table 8 (above) demonstrates that the exemplary kibble (Ex. II) required less force to break and the deformation point was higher than the comparative kibbles (Comp. Ex. 4-11).

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A pet food composition comprising:
from about 10 wt.% to about 50 wt.% protein;
from about 10 wt.% to about 40 wt.% fat; and
up to about 20 wt.% fiber;
wherein the pet food composition has a peak force of from about 5 kg to about 11 kg.

2. The pet food composition according to claim 1, further comprising a hydrolyzed protein.

3. The pet food composition according to claim 1, wherein the hydrolyzed protein comprises a protein source selected from: chicken; fish; soy; and a combination of two or more thereof.

4. The pet food composition according to claim 1, further comprising lactic acid.

5. The pet food composition according to claim 1, wherein the pet food composition has a density of from about 25 lbs/ft³ to about 38 lbs/ft³.

6. The pet food composition according to claim 1, wherein the fiber comprises a prebiotic.

7. The pet food composition according to claim 1, wherein the fiber comprises a bulking fiber.

8. The pet food composition according to claim 1, further comprising an amino acid.

9. The pet food composition according to claim 1, wherein the composition is in the form of a kibble.

10. The pet food composition according to claim 9, wherein the composition is in the form of a multi-layer kibble.

11. The pet food composition according to claim 10, wherein the multi-layer kibble comprises a coating comprising a palatant.

12. (canceled)

13. The pet food composition according to claim 1, wherein the pet food composition is substantially free of humectants.

14. The pet food composition according to claim 1, wherein the fiber comprises a fibrillary network.

15. The pet food composition according to claim 14, wherein the fibrillary network comprises pores or voids.

16. The pet food composition according to claim 15, wherein the pet food composition has a porosity effective to absorb fat from the coating.

17. The pet food composition according to claim 9, wherein the kibble has a length of from about 3 mm to about 10 mm.

18. The pet food composition according to claim 9, wherein the kibble has a width of from about 5 mm to about 20 mm.

19. The pet food composition according to claim 9, wherein the kibble is substantially round.

20. The pet food composition according to claim 1, wherein the pet food composition has a deformation distance of from about 1 mm to about 3 mm.

21. A method for:
increasing caloric intake;
increasing body weight;
improving quality of life;
reducing atrophy (e.g., muscular atrophy);
enhancing immunity; and/or
reducing bone demineralization, in a companion animal, comprising administering to a companion animal in need thereof, the pet food compositions according to claim 1.

22-25. (canceled)
